(19) United States
(12) Patent Application Publication
(10) Pub. No.: US 2018/0177004 A1
(43) Pub. Date: Jun. 21, 2018

(54) ROTATING TRAY ASSEMBLY AND COOKING APPLIANCE

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Haidong Lu, Foshan (CN); Bo Liu, Foshan (CN)

(73) Assignees: GUANGDONG MIDEA KITCHEN APPLIANCES MANUFACTURING CO., LTD., Foshan (CN); MIDEA GROUP CO., LTD., Foshan (CN)

(21) Appl. No.: 15/647,276

(22) Filed: Jul. 12, 2017

(30) Foreign Application Priority Data
Dec. 15, 2016 (CN) 201621380353.X

(51) Int. Cl. H05B 6/64

(52) U.S. Cl. CPC H05B 6/6479; H05B 6/6402; H05B 6/6411

(57) ABSTRACT

Embodiments of the invention provides a rotating tray assembly and a cooking appliance. The cooking appliance is provided with a cooking cavity. The rotating tray assembly includes: a rotating tray body that is rotatably mounted on a bottom wall of the cooking cavity and is provided with a water groove for holding water. The rotating tray assembly provided by this solution comprises the rotating tray body that is mounted in the cooking cavity of the cooking appliance for use and is provided with the water groove. When the cooking appliance is used, food is placed on the rotating tray body and water is added to the water groove of the rotating tray body, and then the food is heated.

### CROSS-REFERENCES TO RELATED APPLICATIONS

The present application claims the priority and benefit of Chinese Patent Application No. 201621380353.X, filed on Dec. 15, 2016, the contents of which is incorporated herein by reference in its entirety.

### TECHNICAL FIELD

The present invention relates to the field of cooking appliances, and more specifically, to a rotating tray assembly and a cooking appliance.

### BACKGROUND ART

At present, in the food heating process of a cooking appliance, such as a microwave oven, an electric oven or the like, water in food may be lost, resulting in that the heated food is dry and the taste and nutrition of the food are affected.

### SUMMARY OF THE INVENTION

One embodiment of the present invention provides a rotating tray assembly used in a cooking appliance that is provided with a cooking cavity. The rotating tray assembly comprises: a rotating tray body that is rotatably mounted on a bottom wall of the cooking cavity and is provided with a water groove for holding water.

The rotating tray assembly provided by this solution comprises the rotating tray body that is mounted in the cooking cavity of the cooking appliance for use and is provided with the water groove for holding water. When the cooking appliance is used, food is placed on the rotating tray body and water is added to the water groove of the rotating tray body, and then the food is heated; and in the heating process, the water in the water groove warms up to evaporate into vapor and the vapor permeates the food to replenish water to the food and prevent the food from drying, thereby keeping the taste and nutrition of the food.

In the above technical solution, the water groove includes one or more grooves.

There are many options for specific ways of providing the water groove in the rotating tray body. There may be one or more water grooves. The water groove may be an annular groove, or a plurality of small grooves arranged at intervals, and may also be a combination of an annular groove and small grooves with no special requirement on the shape of any small groove.

In any of the above technical solutions, preferably, the grooves include one or more annular grooves.

In this solution, the water groove is the annular groove. The water groove designed in this way is large in captivity, and the manufacturing difficulty of the rotating tray body is low. Also, the rotating tray body is easy to clean after food heating.

In any of the above technical solutions, optionally, the water groove includes a plurality of annular grooves that are distributed as concentric circles.

In this solution, the water groove includes a plurality of annular grooves, and such a design increases the water holding capacity of the rotating tray body so as to guarantee that sufficient vapor may be generated when heating food to replenish water for the food and prevent the food from drying, thereby keeping the taste and nutrition of the food.

In any of the above technical solutions, preferably, the plurality of annular grooves is arranged next to an edge of the rotating tray body.

In this solution, the plurality of annular grooves is arranged next to the edge of the rotating tray body such that a large area is vacated on the inner side of the annular grooves. When being heated, food is placed at the center position of the rotating tray body to keep a certain distance between the food and the water groove, thereby preventing the food from being spoiled due to direct contact with water.

In any of the above technical solutions, preferably, the rotating tray assembly also comprises a cover matched with the rotating tray body in use. A confined space for accommodating food is formed between the cover and the rotating tray body and at least one of the grooves is located in the confined space when the cover is placed on the rotating tray body.

When heating food, the food is placed on the rotating tray body in a position next to the bottom of the cooking cavity. After water in the water groove turns into vapor, the vapor may rise due to a high temperature and finally gather at the top of the cooking cavity. The vapor can only replenish water for the food in the very short time of passing through the food with a normal effect. For this reason, this solution provides the cover matched with the rotating tray body in use. The cover may cover the food placed on the rotating tray body and at least one water groove such that a confined space is formed between the rotating tray body and the cover. Thus, after the water in the water groove located in the confined space evaporates, the vapor is confined within the confined space to continuously replenish water for the food, thereby improving the water replenishing effect and effectively preventing the food from drying.

Preferably, a handle is disposed on the cover so that a user can pick up and place the cover conveniently.

In any of the above technical solutions, preferably, a limiting portion is disposed on the rotating tray body for matching with the cover to limit relative position of the cover and the rotating tray body.

When the cover is placed on the rotating tray body, the limiting portion is matched with the cover to limit the relative position of the cover and the rotating tray body so as to guarantee that the cover may cover the corresponding water groove. Specifically, the limiting portion may be a limiting groove, a limiting lug boss, or the like.

In the above technical solution, preferably, the rotating tray body and/or the cover are/is made of glass.

The rotating tray body and the cover are made of glass to guarantee that the rotating tray body and the cover are capable of enduring high temperature. For a cooking appliance having a microwave heating function, the cover made of glass allows microwaves to penetrate it easily, and therefore, the food heating efficiency may be improved.

An embodiment in a second aspect of the present invention provides a cooking appliance, comprising: a cooking cavity and a rotating tray assembly as provided in any embodiment in the first aspect of the present invention.

The cooking appliance provided in the embodiment in the second aspect of the present invention is provided with the rotating tray assembly provided in any embodiment in the first aspect of the present invention, and thus has all the beneficial effects of the rotating tray assembly provided in any one of the above embodiments, which are not described redundantly herein.

Specifically, the cooking appliance includes a microwave oven, an electric oven and the like.

An embodiment in a third aspect of the present invention provides a cooking appliance, comprising a cooking cavity, wherein a water groove for holding water is arranged on an inner side of a wall of the cooking cavity.

When the cooking appliance is used, food is placed inside the cooking cavity and water is added to the water groove, and then the food is heated; and in the heating process, the water in the water groove warms up to evaporate into vapor and the vapor permeates the food to replenish moisture to the food and prevent the food from drying, thereby keeping the taste and nutrition of the food.

Specifically, the cooking appliance includes a microwave oven, an electric oven and the like.

The additional aspects and advantages of the present invention will become obvious from the following part of descriptions, or will be known through the practice of the present invention.

### BRIEF DESCRIPTION OF THE DRAWINGS

The above and/or additional aspects and advantages of the present invention will become obvious and easily understandable from the following descriptions on embodiments in conjunction with the accompanying drawings in which:

FIG. 1 is a structural diagram of a rotating tray assembly provided by an embodiment of the present invention;

FIG. 2 is an A-A sectional structural diagram of the rotating tray assembly shown in FIG. 1;

FIG. 3 is a structural diagram of a cooking appliance provided by an embodiment of the present invention;

FIG. 4 is a structural diagram of a rotating tray assembly provided by another embodiment of the present invention;

FIG. 5 is a structural diagram of the rotating tray assembly shown in FIG. 4 in another state;

FIG. 6 is a B-B sectional structural diagram of the rotating tray assembly shown in FIG. 5; and

FIG. 7 is an enlarged structural diagram of section C shown in FIG. 5.

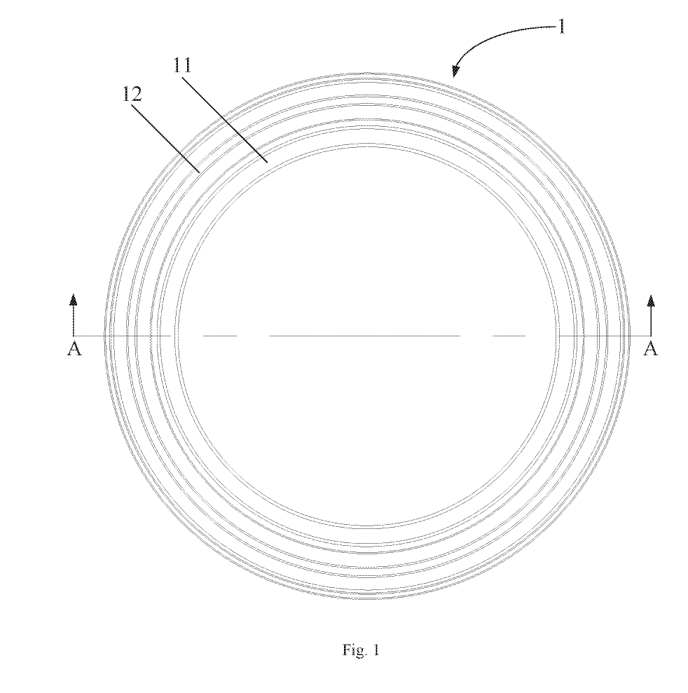

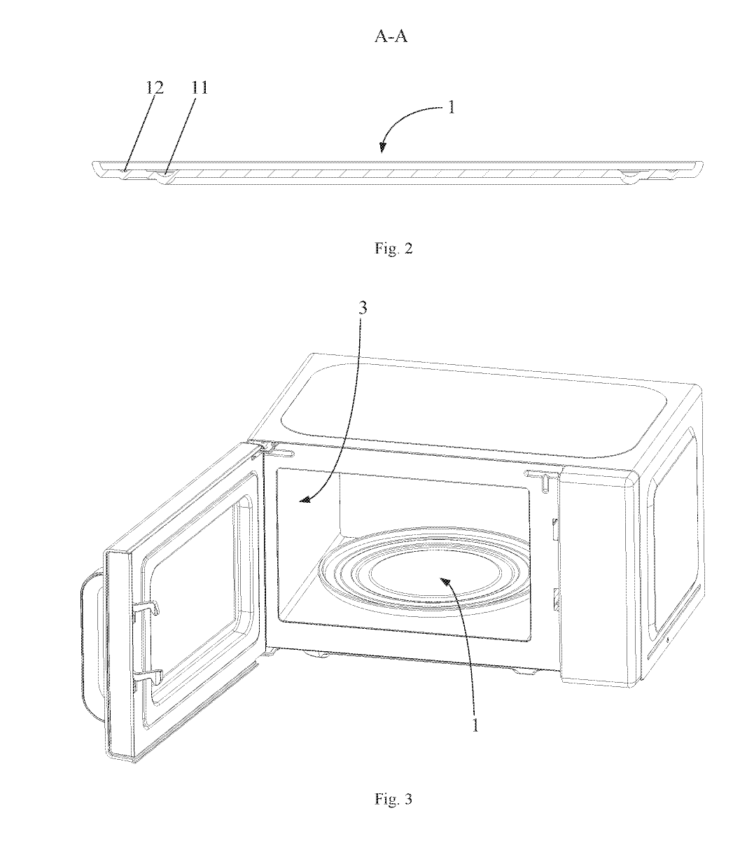

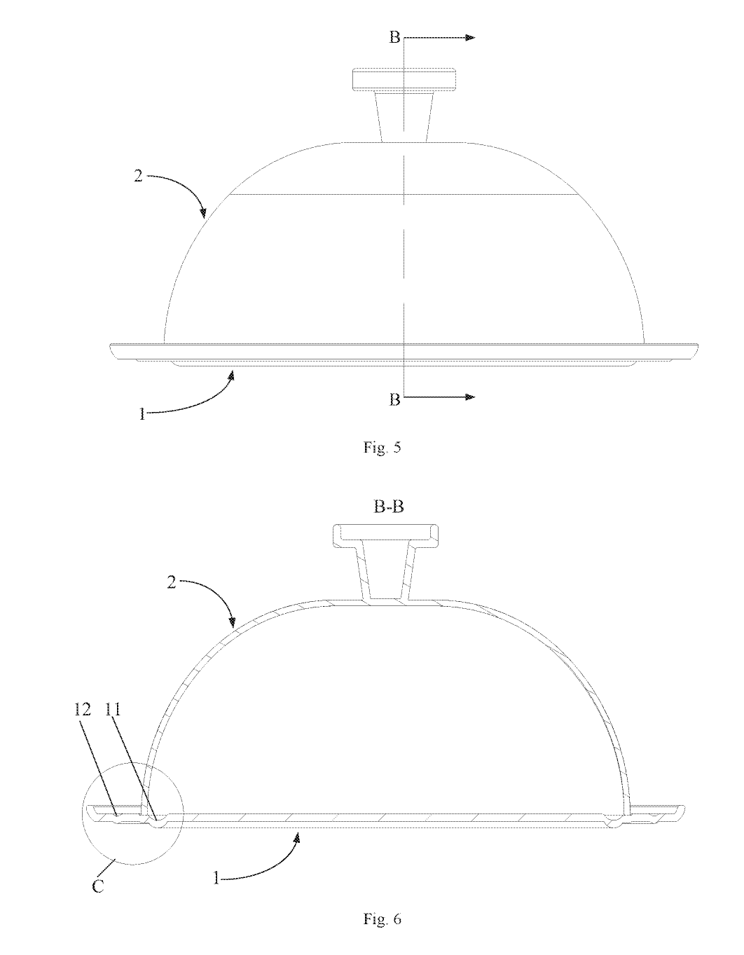

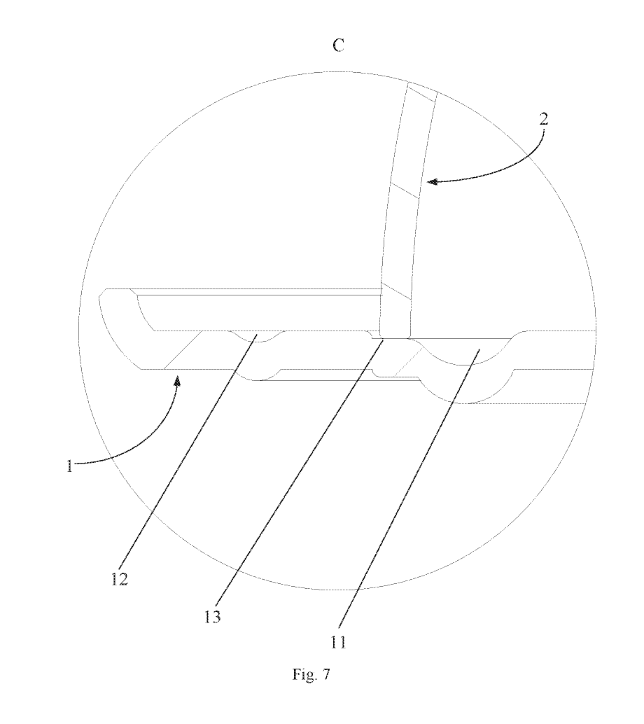

Here, reference numbers in FIG. 1 to FIG. 7 and corresponding member names are shown below:

1, rotating tray body; 11, inner water groove; 12, outer water groove; 13, limiting groove; 2, cover; and 3, cooking cavity.

### DETAILED DESCRIPTION OF THE EMBODIMENTS

To provide a clearer understanding of the above-described objectives, features and advantages of the present invention, the present invention will be further destined in detail in conjunction with the accompanying drawings and specific embodiments. It needs to be noted that the embodiments of the present invention and features in the embodiments may be combined with one another without conflict.

While many specific details are set forth in the following descriptions to provide a full understanding of the present invention, the present invention may also be implemented in other ways than that is described herein. Therefore, the scope of protection of the present invention is not limited by the specific embodiments disclosed below.

As shown in FIG. 1 and FIG. 3, an embodiment in the first aspect of the present invention provides a rotating tray assembly used in a cooking appliance that is provided with a cooking cavity 3. The rotating tray assembly comprises a rotating tray body 1 that is rotatably mounted on a bottom wall of the cooking cavity 3 and is provided with a water groove for holding water.

The rotating tray assembly provided by this solution comprises the rotating tray body 1 that is mounted in the cooking cavity 3 of the cooking appliance for use and is provided with the water groove for holding water. When the cooking appliance is used, food is placed on the rotating tray body 1 and water is added to the water groove of the rotating tray body 1, and then the food is heated; and in the heating process, the water in the water groove warms up to evaporate into vapor and the vapor permeates the food to replenish water to the food and prevent the food from drying, thereby keeping the taste and nutrition of the food.

Specifically, the water groove includes an inner water groove 11 and an outer water groove 12 distributed as concentric circles.

In this solution, the water groove includes a plurality of annular grooves, and such a design increases the water holding capacity of the rotating tray body 1 so as to guarantee that sufficient vapor may be generated when heating food to replenish water for the food and prevent the food from drying, thereby keeping the taste and nutrition of the food.

In any of the above technical solutions, preferably, the inner water groove 11 and the outer water groove 12 are arranged next to the edge of the rotating tray body 1.

In this solution, the inner water groove 11 and the outer water groove 12 are arranged next to the edge of the rotating tray body 1 such that a large area is vacated on the inner side of the inner water groove 11. When being heated, food is placed at the center position of the rotating tray body 1 to keep a certain distance between the food and the water groove, thereby preventing the food from being spoiled due to direct contact with water.

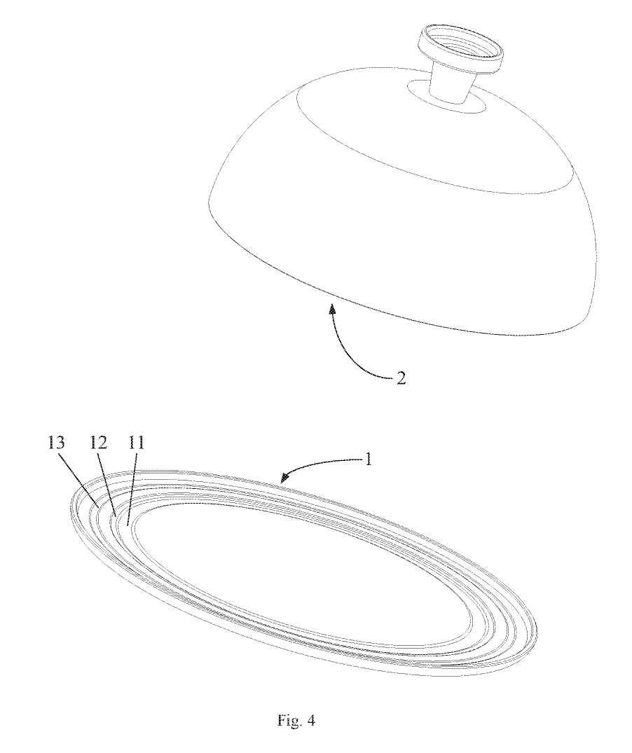

As shown in FIG. 4 to FIG. 7, in any of the above technical solutions, preferably, the rotating tray assembly also comprises a cover 2 matched with the rotating tray body 1 in use. A confined space for accommodating food is formed between the cover 2 and the rotating tray body 1 and the inner groove 11 is located in the confined space when the cover 2 is placed on the rotating tray body 1.

When heating food, the food is placed on the rotating tray body 1 in a position next to the bottom of the cooking cavity 3. After water in the water groove turns into vapor, the vapor may rise due to a high temperature and finally gather at the top of the cooking cavity 3. The vapor can only replenish water for the food in the very short time of passing through the food with a normal effect. For this reason, this solution provides the cover 2 matched with the rotating tray body 1 in use. The cover 2 may cover the food placed on the rotating tray body 1 and the inner water groove 11 such that a confined space is formed between the rotating tray body 1 and the cover 2. Thus, after the water in the water groove located in the confined space evaporates, the vapor is confined within the confined space to continuously replenish water for the food, thereby improving the water replenishing effect and effectively preventing the food from drying.

Preferably, a handle is disposed on the cover 2 so that a user can pick up and place the cover 2 conveniently.

In any of the above technical solutions, preferably, a limiting groove 13 is arranged in the rotating tray body 1 for matching with the cover 2 to limit the relative position of the cover 2 and the rotating tray body 1.

When the cover 2 is placed on the rotating tray body 1, the edge of the bottom of the cover 2 is inserted into the limiting groove 13 to limit the relative position of the cover 2 and the rotating tray body 1 so as to guarantee that the cover 2 may cover the inner water groove 11.

In any of the above technical solutions, preferably, the rotating tray body 1 and/or the cover 2 are/is made of glass.

The rotating tray body 1 and the cover 2 are made of glass to guarantee that the rotating tray body 1 and the cover 2 are capable of enduring high temperature. For a cooking appliance having a microwave heating function, the cover 2 made of glass allows microwaves to penetrate it easily, and therefore, the food heating efficiency may be improved.

As shown in FIG. 3, an embodiment in the second aspect of the present invention provides a cooking appliance, comprising a cooking cavity 3 and the rotating tray assembly as provided in any embodiment in the first aspect of the present invention. The rotating tray body 1 in the rotating tray assembly is rotatably mounted on the bottom wall of the cooking cavity 3.

The cooking appliance provided in the embodiment in the second aspect of the present invention is provided with the rotating tray assembly provided in any embodiment in the first aspect of the present invention, and thus has all the beneficial effects of the rotating tray assembly provided in any one of the above embodiments, which are not described redundantly herein.

Specifically, the cooking appliance includes a microwave oven, an electric oven and the like.

An embodiment in a third aspect of the present invention provides a cooking appliance, comprising a cooking cavity. A ceramic plate for holding food is disposed on the bottom wall of the cooking cavity, and a water groove for holding water is arranged in the ceramic plate.

When the cooking appliance is used, food is placed inside the cooking cavity and water is added to the water groove in the ceramic plate, and then the food is heated; and in the heating process, the water in the water groove warms up to evaporate into vapor and the vapor permeates the food to replenish moisture to the food and prevent the food from drying, thereby keeping the taste and nutrition of the food.

Specifically, there are many options for ways of arranging the water groove in the ceramic body. There may be one or more water grooves. The water groove may be an annular groove, or a plurality of small grooves arranged at intervals, and may also be a combination of an annular groove and small grooves with no special requirement on the shape of any small groove.

Here, the cooking appliance includes a microwave oven, an electric oven and the like.

In the descriptions of the present invention, orientations or positional relations indicated by the terms “up”, “down”, “top”, “bottom” and the like are shown based on the figures, and are merely intended to facilitate and simplify description of the present invention rather than indicating or implying that the signified devices or elements may have specific orientations or be constructed and operated in specific orientations, and thus may not be interpreted as limitations to the present invention.

In the descriptions of the present specification the descriptions involving the terms “an embodiment”, “some embodiments”, “specific embodiment” and the like refer to that specific features, structures, materials or characteristics described in conjunction with the embodiment(s) or example(s) are included in at least one embodiment or example. In this specification, the exemplary expressions of the above terms do not necessarily refer to the same embodiment or example. Also, the described specific features, structures, materials or characteristics may be combined in a proper way in any one or more embodiments or examples.

In the descriptions of the present invention, the terms “connection”, “mounting”, “fixing” and the like may all be interpreted in a broad sense. For example, “connection” may be fixed connection, and may also be detachable connection or integrated connection; and it may be direct connection or indirect connection by means of an intermediation. For those of ordinary skill in the art, the specific meanings of the above-mentioned terms in the present invention may be understood according to specific situations.

The above descriptions are merely on the preferred embodiments of the present invention and are not intended to limit the present invention. For those skilled in the art, various alterations and variations may be made to the present invention. Any modifications, equivalent replacements, improvements and the like made within the spirit and principles of the present invention should all fall into the scope of the protection of the present invention.

What is claimed is:

1. A rotating tray assembly used in a cooking appliance that is provided with a cooking cavity, comprising:
a rotating tray body that is rotatably mounted on a bottom wall of the cooking cavity and is provided with a water groove for holding water.

2. The rotating tray assembly according to claim 1, wherein
the water groove includes one or more grooves.

3. The rotating tray assembly according to claim 2, wherein
the grooves include one or more annular grooves.

4. The rotating tray assembly according to claim 2, wherein
the water groove includes a plurality of annular grooves that are distributed as concentric circles.

5. The rotating tray assembly according to claim 4, wherein
the plurality of annular grooves is arranged next to an edge of the rotating tray body.

6. The rotating tray assembly according to claim 2, further comprising:
a cover matched with the rotating tray body in use, wherein a confined space for accommodating food is formed between the cover and the rotating tray body and at least one of the grooves is located in the confined space when the cover is placed on the rotating tray body.

7. The rotating tray assembly according to claim 3, further comprising:
a cover matched with the rotating tray body in use, wherein a confined space for accommodating food is formed between the cover and the rotating tray body and at least one of the grooves is located in the confined space when the cover is placed on the rotating tray body.

8. The rotating tray assembly according to claim 4, further comprising:
a cover matched with the rotating tray body in use, wherein a confined space for accommodating food is formed between the cover and the rotating tray body and at least one of the grooves is located in the confined space when the cover is placed on the rotating tray body.

9. The rotating tray assembly according to claim 5, further comprising:
a cover matched with the rotating tray body in use, wherein a confined space for accommodating food is formed between the cover and the rotating tray body and at least one of the grooves is located in the confined space when the cover is placed on the rotating tray body.

10. The rotating tray assembly according to claim 6, wherein
a limiting portion is disposed on the rotating tray body for matching with the cover to limit relative position of the cover and the rotating tray body.

11. The rotating tray assembly according to claim 7, wherein
a limiting portion is disposed on the rotating tray body for matching with the cover to limit relative position of the cover and the rotating tray body.

12. The rotating tray assembly according to claim 8, wherein
a limiting portion is disposed on the rotating tray body for matching with the cover to limit relative position of the cover and the rotating tray body.

13. The rotating tray assembly according to claim 9, wherein
a limiting portion is disposed on the rotating tray body for matching with the cover to limit relative position of the cover and the rotating tray body.

14. The rotating tray assembly according to claim 6, wherein
the rotating tray body and/or the cover are/is made of glass.

15. The rotating tray assembly according to claim 7, wherein
the rotating tray body and/or the cover are/is made of glass.

16. The rotating tray assembly according to claim 8, wherein
the rotating tray body and/or the cover are/is made of glass.

17. The rotating tray assembly according to claim 9, wherein
the rotating tray body and/or the cover are/is made of glass.

18. A cooking appliance, comprising: a cooking cavity and a rotating tray assembly, wherein the rotating tray assembly comprises a rotating tray body that is rotatably mounted on a bottom wall of the cooking cavity and is provided with a water groove for holding water.

19. The cooking appliance according to claim 18, wherein
the water groove includes one or more grooves.

20. A cooking appliance, comprising: a cooking cavity, wherein a water groove for holding water is arranged on an inner side of a wall of the cooking cavity.
